(19) United States
(12) Patent Application Publication
(10) Pub. No.: US 2008/0120481 A1
(43) Pub. Date: May 22, 2008

(54) Methods For Protection Of Data Integrity Of Updatable Data Against Unauthorized Modification

(75) Inventors: Boris Dolgunov, Ramat Gan (IL); Rami Koren, Kfar Saba (IL)

Correspondence Address: MARK M. FRIEDMAN, C/O DISCOVEY DISPATCH , 9003 FLIRIN WAY, UPPER MARLBORO, MD, 20772, US

(73) Assignee: SANDISK IL LTD., Kfar Saba (IL)

(21) Appl. No.: 11/837,544

(22) Filed: Aug. 13, 2007

Related U.S. Application Data
(60) Provisional application No. 60/866,073, filed on Nov. 16, 2006.

(51) Int. Cl. G06F 12/00

(52) U.S. Cl. 711/161; 711/E12.001

(57) ABSTRACT

The present invention discloses methods for protecting data integrity of updatable data against unauthorized modification. A method for protecting data integrity of updatable data in a storage system, the method including the steps of: storing a data copy of the data in the storage system; upon storing the data copy, transforming the data copy into at least one transformed copy of the data; storing at least one transformed copy in the storage system; upon a request to read the data, reading the data copy and at least one transformed copy; transform-comparing the data copy and at least one transformed copy; and designating the data integrity of the data as verified contingent upon the data copy and at least one transformed copy being identical.

### RELATED APPLICATIONS

This patent application claims priority under 35 U.S.C. §119(e) to U.S. Provisional Application No. 60/866,073, filed Nov. 16, 2006, which is hereby incorporated by reference in its entirety.

This patent application is related to U.S. patent application Ser. No. ______ of the same inventors, which is entitled “SYSTEMS FOR PROTECTION OF DATA INTEGRITY OF UPDATABLE DATA AGAINST UNAUTHORIZED MODIFICATION” and filed on the same day as the present application. This patent application, also claiming priority to U.S. Provisional Application No. 60/866,073, is incorporated in its entirety as if fully set forth herein.

### FIELD AND BACKGROUND OF THIS INVENTION

The present invention relates to methods for protecting data integrity of updatable data against unauthorized modification.

Data integrity is a well-known requirement for digital storage systems. One of the known risks to data integrity is the unauthorized modification of updatable data in storage devices. The prior art uses two main methods for protecting the integrity of such data:
(1) redundant storage (i.e. storage of more than one copy of the data), used against non-deterministic and limited fault attacks in which an attacker can cause a random or partial change in the stored data; and
(2) encrypted storage, used against deterministic fault attacks in which an attacker is able to set new values for the stored data.

These prior art methods suffer from deficiencies and limitations in which:
(a) redundant storage does not protect the data against truncation to a fixed value that, if applied to both copies of the data, creates a seemingly valid result; and
(b) hashed or encrypted storage, while being strong enough to detect the changes in data, requires intensive and frequent calculations and may overload the computer when frequent changes to the data are made.

Both methods mentioned above do not take advantage of the fact that internal-process storage (i.e. data storage that is internal to a processing system) is typically a “victim” of only limited fault attacks.

It would be desirable to have methods for protecting the integrity of updatable data in internal-process storage devices without suffering from the above-mentioned prior-art deficiencies and limitations.

### SUMMARY OF THE INVENTION

It is the purpose of the present invention to provide methods for protecting data integrity of updatable data against unauthorized modification.

For the purpose of clarity, several terms which follow are specifically defined for use herein. The term “redundant storage” is used herein to refer to the storage of more than one copy of the same data for the purpose of data security. The term “internal-process storage” is used herein to refer to data storage that is internal to a processing system, meaning that there is no direct access control to the reading and writing of data. For such storage, an attacker must apply “remote” means to attack the data. Such remote means typically attack large areas of the storage, and cannot deterministically change the data at the bit or byte level. Conversely, the term “external-process storage” is used herein to refer to data storage that is external to a processing system, meaning that there is direct access control to the reading and writing of data.

The term “data integrity” is used herein to refer to a condition that exists when stored data is unchanged from the source data of the stored data, and has not been accidentally or maliciously modified, altered, or destroyed. The term “updatable data” is used herein to refer to stored data that has to be updated while a device is operating.

The term “fault attack” is used herein to refer to an abnormal condition or defect at a component, equipment, or sub-system level, which may lead to a failure, improper functioning, or a change in the data. The term “non-deterministic fault attack” is used herein to refer to a fault attack wherein an attacker is able to make only random changes to the system or its sub-system. The term “limited fault attack” is used herein to refer to a fault attack wherein an attacker is limited to making only some specific changes. For example, the attacker cannot specifically set each data value; however, the attacker can force all bits to zero-logic or one-logic values.

The terms “transform comparator”, “transform-comparing”, and “transform-compare” are used herein to refer to an operation between an original copy and transformed copies of the same data in which the respective values of the copies are compared either by applying the transformation to the original copy, or by applying an inverse transformation to the transformed copies. The term “digest” is used herein to refer to a unique cryptographic value calculated from data. The term “secret key” is used herein to refer to a digital key used for data encryption and/or scrambling.

An essential feature of the present invention is an innovative improvement of the redundant-storage method that overcomes the two deficiencies of the prior art mentioned above. Methods of the present invention are similar to the prior art in the sense that the updatable data is kept in redundant copies. However, methods of the present invention maintain a predetermined distinction between the redundant copies. Such a distinction prevents attacks such as the ones mentioned above.

In a preferred embodiment of the present invention, at least one of the two data copies of the redundant storage is deterministically modified to contain different data values than the other data copy. For example, by performing a XOR logic operation on each byte of the data with the previous byte, starting with the second byte of the data. Such an operation creates a modified version of the data that can be easily checked against the original version by performing the same operation on the original version and comparing the two versions of the data.

The present invention can also be implemented effectively when many independent and relatively-small portions of data have to be protected. Such a situation is typical for temporal software variables (e.g. memory allocated for a stack of data segments). In such a case, simple non-invertible functions can be applied to the data. Such functions are insurmountable by an attacker. For example:

Data Copy=Data XOR (Data² OR C) mod 2ⁿ;

wherein n is the number of bits in a CPU word, and C is a constant. The squaring operation is a non-linear operation, and therefore the data copy number will differ from the original number in most of the bits.

In another preferred embodiment of the present invention, at least one of the two data copies is scrambled with a secret key, so that the attacker cannot create two valid data copies of the updatable information. Any change in one of the data copies is detected by decrypting the encrypted data copy, or encrypting the original data copy, and comparing the two data copies. For example, a software variable and its copy are stored in RAM. The copy is modified using a simple transformation such as:

Copy=Rotate left 5 bit (Data XOR C); wherein C is a secret key.

Further explanations of the present invention can be found in the Appendix.

Therefore, according to the present invention, there is provided for the first time a method for protecting data integrity of updatable data in a storage system, the method including the steps of: (a) storing a data copy of the data in the storage system; (b) upon storing the data copy, transforming the data copy into at least one transformed copy of the data; (c) storing at least one transformed copy in the storage system; (d) upon a request to read the data, reading the data copy and at least one transformed copy; (e) transform-comparing the data copy and at least one transformed copy; and (f) designating the data integrity of the data as verified contingent upon the data copy and at least one transformed copy being identical.

Preferably and alternatively, the step of transforming includes transforming using an invertible or a non-invertible function.

Most preferably and alternatively, the function is linear or non-linear.

Preferably, the step of transforming includes transforming using a secret key.

Preferably, the step of transforming includes scrambling the data copy.

Preferably, the step of transforming includes scrambling external-process storage data to protect against unauthorized reading.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1 is a schematic block diagram of the components involved in a data-storage process utilizing the redundant-storage method, according to preferred embodiments of the present invention;

FIG. 2 is a schematic block diagram of the components involved in a data-retrieval process utilizing the redundant-storage method, according to preferred embodiments of the present invention;

FIG. 3 is a simplified flowchart of the data-storage process utilizing the redundant-storage method, according to preferred embodiments of the present invention;

FIG. 4 is a simplified flowchart of the data-retrieval process utilizing the redundant-storage method, according to preferred embodiments of the present invention.

### DESCRIPTION OF THE PREFERRED EMBODIMENTS

The present invention relates to methods for protecting data integrity of updatable data against unauthorized modification. The principles and operation for protecting data integrity of updatable data against unauthorized modification, according to the present invention, may be better understood with reference to the accompanying description and the drawings.

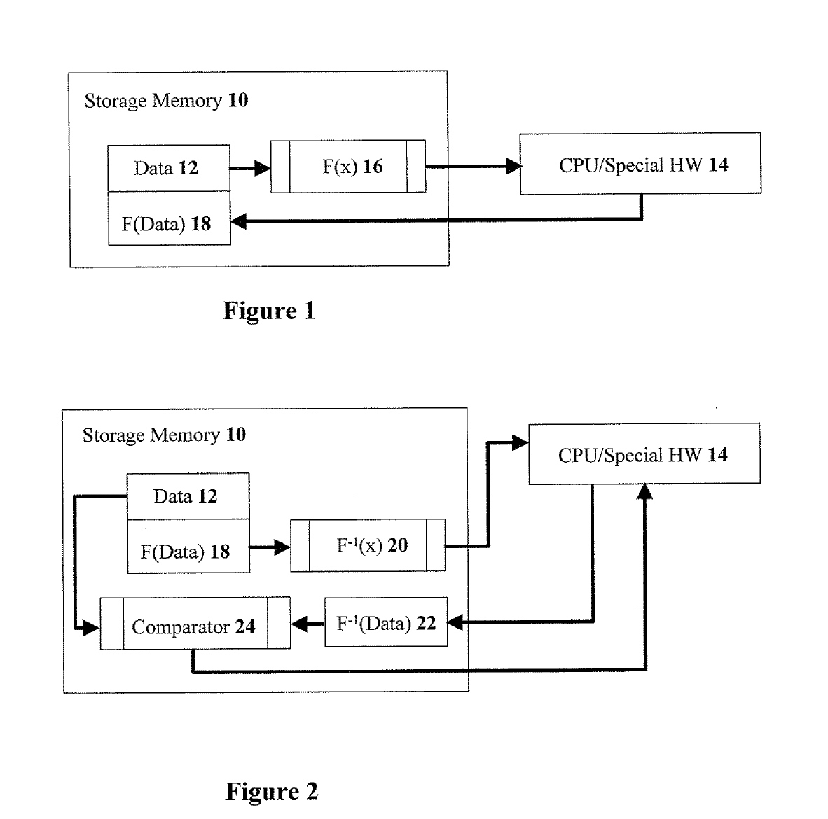

Referring now to the drawings, FIG. 1 is a schematic block diagram of the components involved in a data-storage process utilizing the redundant-storage method, according to preferred embodiments of the present invention. Original data 10, stored in a storage memory 12, is modified by a CPU/special HW 14 using a transformation function 16 (labeled F(x) in FIG. 1), such as performing a XOR logic operation on subsequent bytes, and transformed data 18 (labeled F(Data) in FIG. 1) is stored in storage memory 12.

To CPU/special HW 14 is designated as such to include specially-embedded hardware as well as standard CPU processors in preferred embodiments of the present invention. It is noted that transformation function 16 includes scrambling, which is simple form of encryption. While scrambling algorithms are not as strong as other encryption algorithms, and can be easily broken, scrambling algorithms have the advantages of being very small and easily implemented.

FIG. 2 is a schematic block diagram of the components involved in a data-retrieval process utilizing the redundant-storage method, according to preferred embodiments of the present invention. An inverse-transformation function 20 (labeled F⁻¹(x) in FIG. 2), such as performing a XOR logic operation on subsequent bytes in a reverse order, is applied by CPU/special HW 14 to transformed data 18. Inversely-transformed data 22 (labeled F⁻¹(Data) in FIG. 2) is compared with original data 10 via a transform comparator 24. If the two inputs (i.e. original data 10 and transformed data 22) to comparator 24 are identical, the data integrity is verified to be intact. Otherwise, a fault is detected.

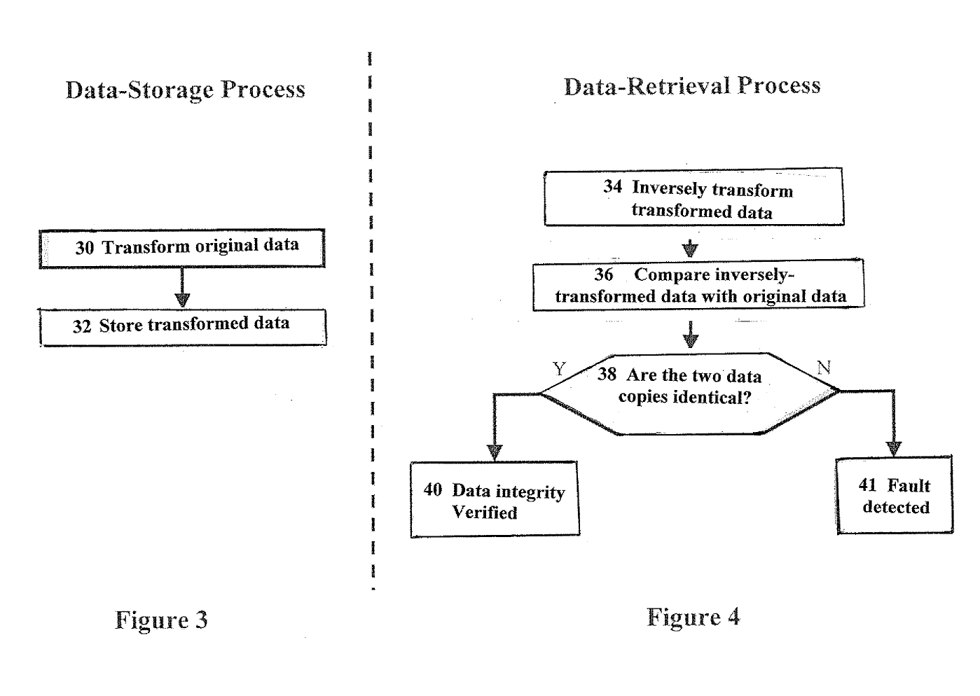

FIG. 3 is a simplified flowchart of the data-storage process utilizing the redundant-storage method, according to preferred embodiments of the present invention. Original data 10 is transformed by transformation function 16 into transformed data 18 (Step 30). Then, transformed data 18 is stored in storage memory 12 (Step 32).

FIG. 4 is a simplified flowchart of the data-retrieval process utilizing the redundant-storage method, according to preferred embodiments of the present invention. Transformed data 18 is inversely-transformed by inverse-transformation function 20 into inversely-transformed data 22 (Step 34). Inversely-transformed data 22 is compared with original data 10 via transform comparator 24 (Step 36). The two data copies (i.e. inversely-transformed data 22 and original data 10) are checked whether they are identical or not (Step 38). If the two data copies are identical, the data integrity is verified to be intact (Step 40). If the two data copies are not identical, a fault is detected (Step 42).

While the invention has been described with respect to a limited number of embodiments, it will be appreciated that many variations, modifications, and other applications of the invention may be made.

### APPENDIX

### Additional Explanation of the Present Invention

Typically, components of embedded secure systems include a secure chipset and an external non-volatile area, which is used for storage of program code and data. The chipset usually includes a secure internal-process area and a special logical domain where secure data is accessible. The secure data is stored in a portion of the memory that is defined as a part of such a secure internal-process area. Such a secure internal-process area is usually protected using hardware or software/firmware protection mechanisms (or combinations thereof).

Typically, the secure chipset has restricted resources, and only limited resources for the storage of secure data. As a result, the main part of the secure data has to be stored externally to the chipset in non-volatile external-process memory. Frequently, such non-volatile external-process memory can be accessed by an attacker, and data can be replaced using malicious code. Therefore, the data that is stored in the chipset (i.e. in the secure internal-process area) and in the non-volatile external-process memory has to be protected against unauthorized changes. Examples of the data that has to be protected include:
(1) temporal software variables that are stored in a stack;
(2) initialization software values (e.g. constant data);
(3) software flags;
(4) secure application data (e.g. counters); and
(5) other internal application data, stored inside the secure internal-process area, that is utilized outside the secure internal-process area as well.

A wide range of attacks can be launched on the system. When data is stored in the chipset in internal registers, the attacker may try to cause a fault using a known technique (e.g. by attacking the registers using a laser beam, electron beam, or any other invasive technique).

An obvious protection method is to maintain a duplicate data copy, and compare the two sets of data before use. Such a method is not effective for the storage of data inside the chipset, and has weaknesses (e.g. potential security holes) when used for data storage in the chipset. As the values of the two data copies are written in the same way, it is possible to generate similar faults in multiple chipset areas.

It also ineffective to sign (i.e. to calculate the digest for) stored data because it is not effective to recalculate the signature of a variable each time the variable is updated. Keeping a separate digest for each data part is not effective because of the restrictions on memory in a secure zone.

The present invention proposes a new method for the protection of the data when an attacker has limited ability to modify data. For example, an attacker can make only random changes in the data, or can set the data only to globally-specific values like all zero-logic or all one-logic. An essential aspect of the method is to store the first data copy in its original form and the second data copy in a transformed form using a special function. The function can be linear or non-linear (e.g. LFSR and T-function).

For the internal-process storage of data, it is enough to store simple invertible functions because the assumption is that an attacker does not have full access to the chipset internals (e.g. chipset HW, RAM, ROM, and non-volatile memory), and is is only able to make limited faults. In such a case, the purpose of the transformation is to have a modified data copy in order to thwart the attacker's ability to generate the same fault twice.

It is also possible to store several data copies to improve the detection capabilities and also possibly for data recovery. In such a case, additional memory is required for the storage of the multiple, encrypted data copies. In order to disable the attacker's ability to copy one data copy to another, the transformation function is slightly modified for each data copy. For example:
Data Copy1=F(Data), Data Copy2=F(Data+1), Data Copy3=F(Data+2).

With such an encryption scheme, each data copy is different, and yet still not invertible by the attacker.

What is claimed is:

1. A method for protecting data integrity of updatable data in a storage system, the method comprising the steps of:
(a) storing a data copy of the data in the storage system;
(b) upon storing said data copy, transforming said data copy into at least one transformed copy of the data;
(c) storing said at least one transformed copy in the storage system;
(d) upon a request to read the data, reading said data copy and said at least one transformed copy;
(e) transform-comparing said data copy and said at least one transformed copy; and
(f) designating the data integrity of the data as verified contingent upon said data copy and said at least one transformed copy being identical.

2. The method of claim 1, wherein said step of transforming includes transforming using an invertible function.

3. The method of claim 2, wherein said function is linear.

4. The method of claim 2, wherein said function is non-linear.

5. The method of claim 1, wherein said step of transforming includes transforming using a non-invertible function.

6. The method of claim 1, wherein said step of transforming includes transforming using a secret key.

7. The method of claim 1, wherein said step of transforming includes scrambling said data copy.

8. The method of claim 1, wherein said step of transforming includes scrambling external-process storage data to protect against unauthorized reading.
